(19) United States
(12) Patent Application Publication
(10) Pub. No.: US 2024/0226834 A1
(43) Pub. Date: Jul. 11, 2024

(54) IN-LINE PROCESS FOR PREPARING PAINT

(71) Applicant: Rohm and Haas Company, Collegeville, PA (US)

(72) Inventors: Edwin A. Nungesser, Horsham, PA (US); Philip R. Harsh, Birdsboro, PA (US); James C. Bohling, Lansdale, PA (US)

(21) Appl. No.: 18/562,902

(22) PCT Filed: Jun. 15, 2022
(86) PCT No.: PCT/US2022/033508

§ 371 Date: Nov. 21, 2023

Related U.S. Application Data
(63) Continuation of application No. 63/221,043, filed on Jul. 13, 2021.

(51) Int. Cl. B01F 35/71; B01F 33/84; B01F 101/30; C08K 3/22; C08K 9/10; C09D 7/41; C09D 7/62; C09D 7/80; C09K 3/22

(52) U.S. Cl. CPC B01F 35/715; B01F 33/84; C08K 9/10; C09D 7/41; C09D 7/62; C09D 7/80; C09K 3/22; B01F 2101/30; C08K 2003/2241

(57) ABSTRACT

The present invention is a process for preparing one or more paints by flowing and merging pre-paints from pre-paint storage tanks into a mixing chamber and into a paint container.

### BACKGROUND OF THE INVENTION

The present invention relates to an in-line process for manufacturing paints, more particularly, an in-line mixing process adapted to manufacture a variety of paints continuously or semi-continuously.

Paints sold in retail outlets are typically produced in bulk by a batch process that includes grinding pigment and extender particles to form a solid dispersion, then combining this dispersion in a so-called letdown stage with binder, thickeners, and other additives. The batch process produces paint bases of different concentrations of pigment and extender that are transported to the retail outlet where colorant is added to the paint to meet the demands of the consumer. This base system model of paint production requires substantial inventory and is further disadvantaged by using a fixed amount of TiO₂ where the flexibility to adjust TiO₂ levels would be desirable. For example, where a colorant requires lower amounts TiO₂ than present in the untinted paint to achieve the desired tint, excess colorant would need to be added to balance the excess TiO₂. The unnecessary costs associated with the use of excess TiO₂ and colorant as well as the additional time required to prepare the final paint are examples of inefficiencies in the base system model that need to be addressed.

An alternative to the base system model is a point-of-sale model where cans of paint are made by concurrent dispensing of binder, pigment, and extender components from separate holding tanks into a paint container, then mixing the contents of the container. (See US 2003/0110101, para [0027] and [0028].) Although this point-of-sale model is an improvement on the base system model, it is still a labor and cost intensive batch process that relies on both the speed of dispensing the materials into a container and the time it takes to mix the materials in the container and to stabilize the viscosity of the final paint.

Accordingly, it would be advantageous to make cans of paint by a more efficient and versatile process.

### SUMMARY OF THE INVENTION

The present invention addresses a need in the art by providing a process for preparing a container of paint comprising the steps of:
a) feeding into a mixing chamber:
an aqueous dispersion of polymer encapsulated TiO₂ particles and a rheology modifier from a first pre-paint storage vessel; and an aqueous dispersion of opacifying pigment-binder hybrid particles and a rheology modifier from a second pre-paint storage vessel; or
either or both of an aqueous dispersion of polymer encapsulated TiO₂ particles and a rheology modifier from the first pre-paint storage vessel; and an aqueous dispersion of opacifying pigment-binder hybrid particles and rheology from the second pre-paint storage vessel; and at least one of the following pre-paints:
an aqueous dispersion of a matting agent and rheology modifier from a third pre-paint storage vessel;
an aqueous dispersion of opacifying pigment particles and a rheology modifier from a fourth pre-paint storage vessel;
an aqueous dispersion of polymer particles and a rheology modifier from a fifth pre-paint storage vessel;
b) mixing the aqueous dispersions in the mixing chamber to form a fully blended paint; and
c) dispensing the fully blended paint into a paint container.

The process of the present invention provides an efficient and rapid way of making a wide variety of paints.

### BRIEF DESCRIPTION OF DRAWINGS

FIG. 1 is a schematic of an apparatus used to make a paint by the process of the present invention.

### DETAILED DESCRIPTION OF THE INVENTION

The present invention is process for preparing a container of paint comprising the steps of:
a) feeding into a mixing chamber:
an aqueous dispersion of polymer encapsulated TiO₂ particles and a rheology modifier from a first pre-paint storage vessel; and an aqueous dispersion of opacifying pigment-binder hybrid particles and a rheology modifier from a second pre-paint storage vessel; or either or both of an aqueous dispersion of polymer encapsulated TiO₂ particles and a rheology modifier from the first pre-paint storage vessel; and an aqueous dispersion of opacifying pigment-binder hybrid particles and rheology from the second pre-paint storage vessel; and at least one of the following pre-paints:
an aqueous dispersion of a matting agent and rheology modifier from a third pre-paint storage vessel;
an aqueous dispersion of opacifying pigment particles and a rheology modifier from a fourth pre-paint storage vessel;
an aqueous dispersion of polymer particles and a rheology modifier from a fifth pre-paint storage vessel;
b) mixing the aqueous dispersions in the mixing chamber to form a fully blended paint; and
c) dispensing the fully blended paint into a paint container.

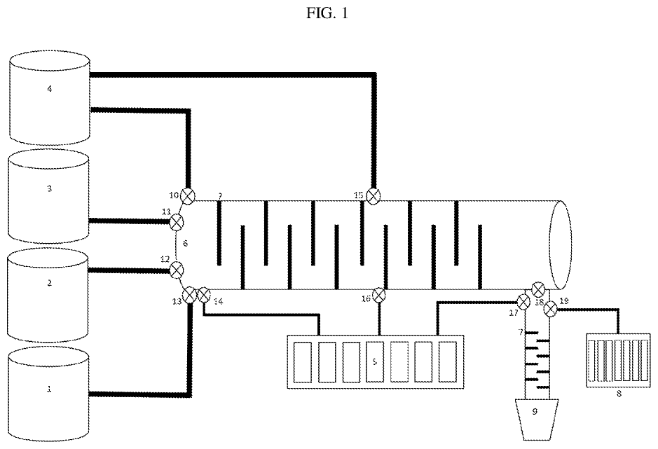

FIG. 1 illustrates an example of a preferred apparatus for carrying out the process of the present invention. In a first example of the process of the present invention, an aqueous dispersion of polymer encapsulated TiO₂ particles and rheology modifier stored in pre-paint storage tank (1) and an aqueous dispersion of matting agent and rheology modifier stored in pre-paint storage tank (2) are fed through valves (13) and (12) respectively into mixing chamber (6) fitted with mixing baffles (7) and mixed to form an aqueous dispersion of the polymer encapsulated TiO₂ particles and the matting agent. Mixing chamber (6) is preferably an in-line continuous flow mixer, more preferably an in-line static mixer. The pre-paints in storage tanks (1) and (2) are each blended with a suitable rheology modifier. For example, pre-paint storage tank (1) advantageously contains an ICI builder or an alkali swellable emulsion (ASE), and pre-paint storage tank (2) advantageously contains an ASE), examples of which include a polyacrylic acid, or a hydrophobically modified alkali swellable emulsion (HASE) or a hydroxyethyl cellulose (HEC). A commercial example of an ICI builder is ACRYSOL™ RM-2020 NPR HEUR Rheology Modifier (a Trademark of The Dow Chemical Company or Its Affiliates).

In a second example of the process of the present invention, an aqueous dispersion of opacifying pigment-binder hybrid particles and rheology modifier stored in pre-paint storage tank (3) and the aqueous dispersion of matting agent and rheology modifier stored in pre-paint storage tank (2) are fed through valves (12) and (11) respectively into mixing chamber (6) and mixed to form an aqueous dispersion of the opacifying pigment-binder hybrid particles and the matting agent. In this second aspect, it may be desirable to concurrently feed into mixing chamber (6) an aqueous slurry of opacifying pigment particles stored in pre-paint storage tank (4). Preferably, the opacifying pigment particles are TiO₂ particles. Pre-paint storage tank (3) also comprises a rheology modifier and optionally a water-soluble dispersant such as a polymer comprising structural units of a sulfonic acid monomer or a salt thereof and less than 30 weight percent structural units of acrylic acid or methacrylic acid, based on the weight of the dispersant. More particularly, the water-soluble dispersant comprises from 50% to 80% by weight structural units of a sulfonic acid monomer or a salt thereof, wherein the sulfonic acid monomer is 2-acrylamido-2-methylpropane sulfonic acid or a salt thereof, vinyl sulfonic acid or a salt thereof, 2-sulfoethyl acrylate, 2-sulfoethyl methacrylate, 3-sulfopropyl acrylate, 3-sulfopropyl methacrylate, sodium styrene sulfonate, or 2-propene-1-sulfonic acid or a salt thereof.

In a third example of the process of the present invention, the aqueous dispersion of polymer encapsulated TiO₂ particles and rheology modifier stored in pre-paint storage tank (1) and the aqueous dispersion of opacifying pigment-binder hybrid particles and rheology modifier stored in pre-paint storage tank (3) are fed into mixing chamber (6) and mixed to form an aqueous dispersion of the polymer encapsulated TiO₂ particles and the opacifying pigment-binder hybrid particles. In this aspect, it may be desirable to concurrently feed into mixing chamber (6) an aqueous dispersion of matting agent and rheology modifier stored in pre-paint storage tank (2).

In a fourth example of the process of the present invention, the aqueous dispersion of polymer encapsulated TiO₂ particles and rheology modifier stored in pre-paint storage tank (1) or the aqueous dispersion of opacifying pigment-binder hybrid particles and rheology modifier stored in pre-paint storage tank (3) and an aqueous dispersion of polymer particles (i.e., a latex) and rheology modifier stored in latex pre-paint storage tank (5) are fed into mixing chamber (6) and mixed to form an aqueous dispersion of the polymer encapsulated TiO₂ particles or the opacifying pigment-binder hybrid particles and the latex.

Additional materials such as surfactants, dispersants, defoamers, coalescents, additional thickeners, organic opacifying pigments, block additives, photoinitiators, and solvents may be fed from any or all of pre-paint storage tanks (5) into mixing chamber (6) through any or all of valves (14), (16), and (17). Alternatively, it may be desirable to include one or more of a defoamer, a surfactant, and a coalescent in any of the pre-paints.

Colorants are a special class of additives that require special care. For tinted paints, one or more aqueous solutions or dispersions of colorants from colorant addition system (8) is fed into mixing chamber (6) through valve (19), the final paint is formed and then directed into paint container (9).

The aqueous dispersion of polymer encapsulated TiO₂ particles can be prepared by methods known in the art, for example, U.S. Pat. Nos. 8,283,404, 9,234,084, and 9,371,466. The z-average particle size of the polymer encapsulated TiO₂ particles, as measured by dynamic light scattering, is typically in the range of from 200 nm to 500 nm.

As used herein, the term “aqueous dispersion of opacifying pigment-binder hybrid particles” refers to an aqueous dispersion of a) multistage polymer particles comprising 1) a water-occluded core comprising from 20 to 60 weight percent structural units of a salt of a carboxylic acid monomer and from 40 to 80 weight percent structural units of a nonionic monoethylenically unsaturated monomer; 2) a polymeric shell having a T_{g} in the range of from 60° C. and 120° C.; and 3) a polymeric binder layer superposing the shell, wherein the polymeric binder layer has a T_{g} of not greater than 35° C. and comprises structural units of at least one monoethylenically unsaturated monomer. Examples of suitable polymeric binder materials include acrylic, styrene-acrylic, vinyl esters such as vinyl acetate and vinyl versatates, and vinyl ester-ethylene polymeric binders. Acrylic binders comprising structural units of methyl methacrylate and structural units of one or more acrylates such as methyl acrylate, ethyl acrylate, n-butyl acrylate, or 2-ethylhexyl acrylate, are especially preferred, as are styrene-acrylic binders.

The z-average particle size of the opacifying pigment-binder hybrid particles, as measured by dynamic light scattering, is typically in the range of from 300 nm, or from 400 nm, or from 450 nm, to 750 nm, or to 700 nm, or to 600 nm, or to 550 nm. The aqueous dispersion of opacifying pigment-binder hybrid particles can be prepared as described in U.S. Pat. No. 7,691,942 B2. Suitable opacifying pigments include inorganic opacifying pigments having a refractive index of greater than 1.90. TiO₂ and ZnO are examples of inorganic opacifying pigments, with TiO₂ being preferred. Other opacifying pigments include organic opacifying pigments such as opaque polymers (other than opacifying pigment-binder hybrid particles), which could be fed into the mixer from a pre-paint to mix specifically with the polymer encapsulated TiO₂ particles. Although an organic opacifying pigment may be used as a substitute for an inorganic opacifying pigment, it is more desirable to use the organic opacifying pigment as a supplement to augment the efficiency of the inorganic opacifying pigment. The organic opacifying pigment can be added to the mixing chamber from a separate additives tank. ROPAQUE™ ULTRA Opaque Polymers and AQACell HIDE 6299 Opaque Polymers are commercial examples of opaque polymers.

The matting agent fed from the matting agent pre-paint storage tank (2) may be an organic matting agent or an inorganic matting agent. Examples of organic matting agents are aqueous dispersions of polymeric microspheres having a median weight average particle size (D50) in the range of from 0.7 μm, or from 1 μm, and or from 2 μm, and or from 4 μm, to 30 μm, or to 20 μm, or to 13 μm, as measured using a Disc Centrifuge Photosedimentometer (DCP). These organic polymeric microspheres are characterized by being non-film-forming and preferably having a crosslinked low T_{g} core, that is, a crosslinked core having a T_{g}, as calculated by the Fox equation, of not greater than 25° C., or not greater than 15° C., or not greater than 10° C.

The crosslinked core of the organic polymeric microspheres preferably comprises structural units of one or more monoethylenically unsaturated monomers whose homopolymers have a T_{g} of not greater than 20° C. (low T_{g} monomers) such as methyl acrylate, ethyl acrylate, n-butyl acrylate, and 2-ethylhexyl acrylate. Preferably, the crosslinked low T_{g} core comprises, based on the weight of the core, from 50, or from 70, or from 80, or from 90 weight percent, to 99, or to 97.5 weight percent structural units of a low T_{g} monoethylenically unsaturated monomer. n-Butyl acrylate, and 2-ethylhexyl acrylate are preferred low T_{g} monoethylenically unsaturated monomers used to prepare the low T_{g} core.

The crosslinked core further comprises structural units of a multiethylenically unsaturated monomer, examples of which include allyl methacrylate, allyl acrylate, divinyl benzene, trimethylolpropane trimethacrylate, trimethylolpropane triacrylate, butylene glycol (1,3) dimethacrylate, butylene glycol (1,3) diacrylate, ethylene glycol dimethacrylate, and ethylene glycol diacrylate. The concentration of structural units of the multiethylenically unsaturated monomer in the crosslinked microspheres is typically in the range of from 1, or from 2 weight percent, to 9, or to 8, or to 6 weight percent, based on the weight of the core.

The crosslinked polymeric core is preferably clad with high a T_{g} shell, that is, a shell having a T_{g} of at least 50° C., or at least 70° C., or at least 90° C. The shell preferably comprises structural units of monomers whose homopolymers have a T_{g} greater than 70° C. (high T_{g} monomers), such as methyl methacrylate, styrene, isobornyl methacrylate, cyclohexyl methacrylate, and t-butyl methacrylate. The high T_{g} shell preferably comprises at least 90 weight percent structural units of methyl methacrylate.

Examples of inorganic matting agents include talc, clay, mica, and sericite; CaCO₃; nepheline syenite; feldspar; wollastonite; kaolinite; dicalcium phosphate; and diatomaceous earth. Although it is possible to feed a blend of a variety of matting agents into the mixer from a single storage tank, it is desirable to feed different matting agents from separate tanks.

The polymer particles from the latex pre-paint storage tank preferably have a z-average particle size by dynamic light scattering in the range of from 50 nm to 600 nm. Examples of suitable polymeric dispersions include acrylic, styrene-acrylic, urethane, alkyd, vinyl ester (e.g., vinyl acetate and vinyl versatate), and vinyl acetate-ethylene (VAE) polymeric dispersions, and combinations thereof. Acrylic and styrene-acrylic polymeric dispersions typically have a z-average particle size in the range of from 70 nm to 300 nm, while vinyl ester latexes generally have a z-average particle size in the range of from 200 nm to 550 nm as measured using dynamic light scattering. If it is desirable to feed more than one kind of latex into the mixing chamber, the latexes are preferably added from separate latex pre-paint storage tanks.

The concentration and type of rheology modifier included in each pre-paint storage tank is readily predetermined to achieve the desired Brookfield, KU, and ICI viscosity of the final paint. Examples of suitable rheology modifiers include hydrophobically modified ethylene oxide urethane polymers (HEURs); hydrophobically modified alkali swellable emulsion (HASEs); alkali swellable emulsions (ASEs); and hydroxyethyl cellulosics (HECs), and hydrophobically modified hydroxyethyl cellulosic (HMHECs); and combinations thereof.

The process of the present invention provides a way of making a wide variety of paints quickly with minimal cleanup between runs. Significantly, no further mixing is required after the in-line mixed pre-paints are dispensed into the paint container.

1. A process for preparing a container of paint comprising the steps of:
a) feeding into a mixing chamber:
an aqueous dispersion of polymer encapsulated TiO₂ particles and a rheology modifier from a first pre-paint storage vessel; and an aqueous dispersion of opacifying pigment-binder hybrid particles and a rheology modifier from a second pre-paint storage vessel; or
either or both of an aqueous dispersion of polymer encapsulated TiO₂ particles and a rheology modifier from the first pre-paint storage vessel; and an aqueous dispersion of opacifying pigment-binder hybrid particles and rheology from the second pre-paint storage vessel; and at least one of the following pre-paints:
an aqueous dispersion of a matting agent and rheology modifier from a third pre-paint storage vessel;
an aqueous dispersion of opacifying pigment particles and a rheology modifier from a fourth pre-paint storage vessel;
an aqueous dispersion of polymer particles and a rheology modifier from a fifth pre-paint storage vessel;
b) mixing the aqueous dispersions in the mixing chamber to form a fully blended paint; and
c) dispensing the fully blended paint into a paint container.

2. The process of claim 1 wherein in step (a) an aqueous dispersion of polymer encapsulated TiO₂ particles and a rheology modifier from the first pre-paint storage vessel; and an aqueous dispersion of matting agent and rheology modifier from the third pre-paint storage vessel are fed into the mixing chamber.

3. The process of claim 1 wherein in step (a) an aqueous dispersion of opacifying pigment-binder hybrid particles and a rheology modifier from the second pre-paint storage vessel; and an aqueous dispersion of matting agent and rheology modifier from the third pre-paint storage vessel are fed into the mixing chamber.

4. The process of claim 1 wherein in step (a) an aqueous dispersion of polymer encapsulated TiO₂ particles and a rheology modifier from the first pre-paint storage vessel; and an aqueous dispersion of opacifying pigment-binder hybrid particles and a rheology modifier from the second pre-paint storage vessel are fed into the mixing chamber.

5. The process of claim 4 wherein in step (a) an aqueous dispersion of matting agent and rheology modifier from the third pre-paint storage vessel is fed into the mixing chamber.

6. The process of claim 1 wherein in step (a) an aqueous dispersion of polymer encapsulated TiO₂ particles and a rheology modifier from the first pre-paint storage vessel; or an aqueous dispersion of opacifying pigment-binder hybrid particles and a rheology modifier from the second pre-paint storage vessel; and an aqueous dispersion of polymer particles and a rheology modifier from a fifth pre-paint storage tank are fed into the mixing chamber.

7. The process of claim 1 wherein in step (a) one or more materials selected from the group consisting of surfactants, dispersants, defoamers, coalescents, additional thickeners, organic opacifying pigments, block additives, photoinitiators, and solvents are fed into the mixing chamber from one or more storage tanks.

8. The process of claim 7 wherein in step (a) a colorant from a colorant addition system is fed into to the mixing chamber.
